(19) United States
(12) Patent Application Publication
(10) Pub. No.: US 2026/0184638 A1
(43) Pub. Date: Jul. 2, 2026

(54) GYPSUM BOARDS AND METHODS OF MAKING THEM

(71) Applicant: CERTAINTEED GYPSUM, INC., Malvern, PA (US)

(72) Inventors: Dahlia N. AMATO, Malvern, PA (US); Douglas Vincent AMATO, Malvern, PA (US); Lea Clara ERNOULT, Paris (FR); Roger D. JONES, Fleming Island, FL (US); Remi LESPIAT, Devon, PA (US)

(21) Appl. No.: 19/426,218

(22) Filed: Dec. 19, 2025

Related U.S. Application Data
(60) Provisional application No. 63/739,242, filed on Dec. 27, 2024.

(51) Int. Cl. C04B 28/14; C04B 16/08; C04B 103/10; C04B 103/40; C04B 111/00; E04C 2/04

(52) U.S. Cl. CPC C04B 28/14; C04B 16/082; E04C 2/043; C04B 2103/10; C04B 2103/408; C04B 2111/0062; C04B 2201/20; C04B 2201/50

(57) ABSTRACT

A gypsum-based construction material may include a gypsum core. The gypsum core may include a gypsum component, and a polymer reinforced foam component. The polymer reinforced foam component may include a partially hydrolyzed polyvinyl alcohol (PVOH). The gypsum core may further have a nail pull resistance of at least about 60 lbf.

### CROSS-REFERENCE TO RELATED APPLICATION(S)

This application claims priority under 35 U.S.C. § 119 (e) to U.S. Provisional Patent Application No. 63/739,242, entitled “GYPSUM BOARDS AND METHODS OF MAKING THEM,” filed Dec. 27, 2024, by Dahlia N. AMATO et al., which is assigned to the current assignee hereof and is incorporated herein by reference in its entirety.

### FIELD OF THE DISCLOSURE

The present disclosure relates to gypsum boards with improved physical properties and methods of making the same.

### BACKGROUND

Gypsum building products (e.g., known variously as wallboard, ceiling board, plasterboard, and “drywall”) are panels made of a gypsum core sandwiched between two layers of liner, often paper, on the outside surfaces of the gypsum core. They are widely used as construction materials due to their ease of fabrication, high mechanical strength, low thermal conductivity, resistance to spread of fire, and soundproofing properties. The quality of a gypsum board is strongly dependent on its gypsum core, which is fabricated by the hydration of stucco slurry (mainly containing calcium sulfate hemihydrate) into a set body of calcium sulfate dihydrate. To control the properties of gypsum boards, additives are often added to the stucco slurry during the board making process. For example, foaming agents, inorganic compounds, and other additives may be included in the slurry to modulate the physical properties (i.e., surface density, strength, and/or fire resistance properties) of the board. Accordingly, there is a need in the art to find component characteristics, formation methods, and compositions that allow for improved physical properties of gypsum cores in gypsum-based construction materials.

### SUMMARY

According to one aspect, a method of forming a gypsum-based construction material may include providing a stucco-based slurry composition, a pre-formed polymer reinforced component, and a surfactant, forming a pre-foam mixture by combining the pre-formed polymer reinforced component with the surfactant, injecting air into the pre-foam mixture to form a polymer reinforced foam component, mixing the polymer reinforced foam component into the stucco-based slurry composition to form a gypsum-based construction material forming composition, and forming the gypsum-based construction material forming composition into a gypsum-based construction material. The pre-formed polymer reinforced polymer component may include a partially hydrolyzed polyvinyl alcohol (PVOH) at a content of not greater than about 10 wt. % for a total weight of the stucco-based slurry composition.

According to another aspect, a gypsum-based construction material may be formed from a stucco-based slurry composition, and a polymer reinforced foam component. The polymer reinforced foam component may include a partially hydrolyzed polyvinyl alcohol (PVOH) at a content of not greater than about 10 wt. % for a total weight of the stucco-based slurry composition. The gypsum-based construction material may include a gypsum core having a nail pull resistance of at least about 60 lbf.

According to still another aspect, a gypsum-based construction material may be formed from a stucco-based slurry composition, and a polymer reinforced foam component. The polymer reinforced foam component may include a partially hydrolyzed polyvinyl alcohol (PVOH) at a content of not greater than about 10 wt. % for a total weight of the stucco-based slurry composition. The gypsum-based construction material may include a gypsum core having a core hardness of at least about 60 N.

According to another aspect, a gypsum-based construction material may include a gypsum core. The gypsum core may include a gypsum component, and a polymer reinforced foam component. The polymer reinforced foam component may include a partially hydrolyzed polyvinyl alcohol (PVOH). The gypsum core may further have a nail pull resistance of at least about 60 lbf.

According to still another aspect, a gypsum-based construction material may include a gypsum core. The gypsum core may include a gypsum component, and a polymer reinforced foam component. The polymer reinforced foam component may include a partially hydrolyzed polyvinyl alcohol (PVOH). The gypsum core may further have a core hardness of at least about 60 N.

According to yet another aspect, a gypsum-based construction material may include a gypsum core. The gypsum core may include a gypsum component, and a polymer reinforced foam component. The polymer reinforced foam component may include a partially hydrolyzed polyvinyl alcohol (PVOH). The gypsum core may have a core bubble median size (D50) of at least about 80 microns and not greater than about 800 microns, a contacting bubble surface percentage of not greater than about 50%, and an average core hardness of at least about 60 N.

### BRIEF DESCRIPTION OF THE DRAWINGS

The present disclosure may be better understood, and its numerous features and advantages made apparent to those skilled in the art by referencing the accompanying drawings.

FIG. 1 includes a diagram showing a gypsum-based construction material forming method according to embodiments described herein.

Skilled artisans appreciate that elements in the figures are illustrated for simplicity and clarity and have not necessarily been drawn to scale.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present), and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the construction products arts.

Embodiments described herein are generally directed to a gypsum-based construction material and methods of forming the same. More particularly, embodiments described herein are directed to a gypsum-based construction material that includes a gypsum core that may include a polymer reinforced foam component and improved physical properties.

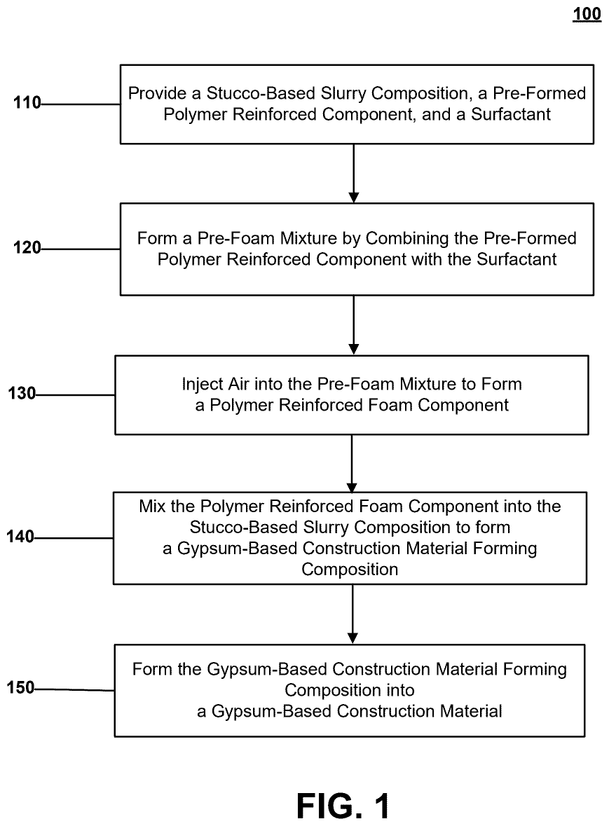

For purposes of illustration, FIG. 1 includes a diagram showing a gypsum-based construction material forming method 100 according to particular embodiments described herein. As shown in FIG. 1, the gypsum-based construction material forming method 100 may include a first step 110 of providing a stucco-based slurry composition, a pre-formed polymer reinforced component, and a surfactant, a second step 120 of forming a pre-foam mixture by combining the pre-formed polymer reinforced component with the surfactant, a third step 130 of injecting air into the pre-foam mixture to form a polymer reinforced foam component, a forth step 140 of mixing the polymer reinforced foam component into the stucco-based slurry composition to form a gypsum-based construction material forming composition, and a fifth step 150 of forming the gypsum-based construction material forming composition into a gypsum-based construction material.

Referring specifically to the first step 110, the pre-formed polymer reinforced component may include a partially hydrolyzed polyvinyl alcohol (PVOH).

According to certain embodiments, the pre-formed polymer reinforced component may include a particular partially hydrolyzed polyvinyl alcohol (PVOH) content, where the partially hydrolyzed polyvinyl alcohol (PVOH) content in the pre-formed polymer reinforced component is equal to the content of the partially hydrolyzed polyvinyl alcohol (PVOH) in weight percent (wt. %) for a total weight of the stucco-based slurry composition. For example, the pre-formed polymer reinforced component may include a partially hydrolyzed polyvinyl alcohol (PVOH) content of not greater than about 10 wt. % for a total weight of the stucco-based slurry composition, such as not greater than about 9.5 wt. % or not greater than about 9.0 wt. % or not greater than about 8.5 wt. % or not greater than about 8.0 wt. % or not greater than about 7.5 wt. % or not greater than about 7.0 wt. % or not greater than about 6.5 wt. % or not greater than about 6.0 wt. % or even not greater than about 5.5 wt. %. According to still other embodiments, the pre-formed polymer reinforced component may include a partially hydrolyzed polyvinyl alcohol (PVOH) content of at least about 0.5 wt. % for a total weight of the stucco-based slurry composition, such as at least about 1.0 wt. % or at least about 1.5 wt. % or at least about 2.0 wt. % or at least about 2.5 wt. % or at least about 3.0 wt. % or at least about 3.5 wt. % or at least about 4.0 wt. % or even at least about 4.5 wt. %. It will be appreciated that the partially hydrolyzed polyvinyl alcohol (PVOH) content in the pre-foam mixture may be within a range between any of the minimum and maximum values noted above. It will be further appreciated that the partially hydrolyzed polyvinyl alcohol (PVOH) content in the pre-foam mixture may be any value between any of the minimum and maximum values noted above.

According to certain embodiments, the particular partially hydrolyzed polyvinyl alcohol (PVOH) may have a particular degree of hydrolysis. For purposes of embodiments described herein, the degree of hydrolysis of a particular component is defined as the measure of the mole % hydroxyl functionality of the component and is measured according to JSK 6726 through a titration method. According to particular embodiments, the partially hydrolyzed polyvinyl alcohol (PVOH) may have a degree of hydrolysis of at least about 85.0%, such as at least about 85.5% or at least about 86.0% or at least about 86.5% or at least about 87.0% or at least about 87.5% or at least about 88.0% or at least about 88.5% or at least about 89.0% or even at least about 89.5%. According to still other embodiments, the partially hydrolyzed polyvinyl alcohol (PVOH) may have a degree of hydrolysis of not greater than about 95%, such as not greater thana about 94.5% or not greater than about 94.0% or not greater than about 93.5% or not greater than about 93.0% or not greater than about 92.5% or not greater than about 92.0% or not greater than about 91.5% or not greater than 91.0% or even not greater than about 90.5%. It will be appreciated that the partially hydrolyzed polyvinyl alcohol (PVOH) may have a degree of hydrolysis within a range between any of the minimum and maximum values noted above. It will be further appreciated that the partially hydrolyzed polyvinyl alcohol (PVOH) may have a degree of hydrolysis of any value between any of the minimum and maximum values noted above.

According to certain embodiments, the particular partially hydrolyzed polyvinyl alcohol (PVOH) may have a particular purity. For purposes of embodiments described herein, the purity of a particular component is defined as the degree to which a substance is free of contaminants and is measured using thermogravimetric analysis to determine weight loss of a sample as a function of temperature using a ramp up from 20° C. to 400° C. with a heating rate of 10° C./min under nitrogen atmosphere, a flow rate of 20 mL/min, and a dry sample weighing of about 1.6 mg of the sample. According to particular embodiments, the partially hydrolyzed polyvinyl alcohol (PVOH) may have a purity of at least about 70, such as at least about 73 or at least about 75 or at least about 78 or at least about 80 or at least about 83 or even at least about 85. According to still other embodiments, the partially hydrolyzed polyvinyl alcohol (PVOH) may have a purity of not greater than about 100, such as not greater thana about 98 or not greater than about 95 or not greater than about 93 or not greater than about 90 or even not greater than about 88. It will be appreciated that the partially hydrolyzed polyvinyl alcohol (PVOH) may have a purity within a range between any of the minimum and maximum values noted above. It will be further appreciated that the partially hydrolyzed polyvinyl alcohol (PVOH) may have a purity of any value between any of the minimum and maximum values noted above.

According to certain embodiments, the particular partially hydrolyzed polyvinyl alcohol (PVOH) may have a particular pH. For purposes of embodiments described herein, the pH of a particular component measured using a pH meter with a 4% solution of the PVOH. According to particular embodiments, the partially hydrolyzed polyvinyl alcohol (PVOH) may have a pH of at least about 5.5, such as at least about 5.6 or at least about 5.7 or at least about 5.8 or at least about 5.9 or at least about 6.0 or even at least about 6.1. According to still other embodiments, the partially hydrolyzed polyvinyl alcohol (PVOH) may have a pH of not greater than about 7.5, such as not greater thana about 7.4 or not greater than about 7.3 or not greater than about 7.2 or not greater than about 7.1 or even not greater than about 7.0. It will be appreciated that the partially hydrolyzed polyvinyl alcohol (PVOH) may have a pH within a range between any of the minimum and maximum values noted above. It will be further appreciated that the partially hydrolyzed polyvinyl alcohol (PVOH) may have a pH of any value between any of the minimum and maximum values noted above.

According to certain embodiments, the particular partially hydrolyzed polyvinyl alcohol (PVOH) may have a particular molecular weight. For purposes of embodiments described herein, the molecular weight of a particular component is defined as the sum of the atomic masses of all atoms in the molecule and is measured using size exclusion chromatography (SEC). According to particular embodiments, the partially hydrolyzed polyvinyl alcohol (PVOH) may have a molecular weight of at least about 20K, such as at least about 25K or at least about 30K or at least about 35K or at least about 40K or at least about 45K or even at least about 50K. According to still other embodiments, the partially hydrolyzed polyvinyl alcohol (PVOH) may have a molecular weight of not greater than about 80K, such as not greater thana about 75K or not greater than about 70K or not greater than about 65K or not greater than about 60K or even not greater than about 55K. It will be appreciated that the partially hydrolyzed polyvinyl alcohol (PVOH) may have a molecular weight within a range between any of the minimum and maximum values noted above. It will be further appreciated that the partially hydrolyzed polyvinyl alcohol (PVOH) may have a molecular weight of any value between any of the minimum and maximum values noted above.

According to certain embodiments, the surfactant may include a particular material. For example, the surfactant may include an alkyl ether sulfate, an ethoxylated surfactant, a lauryl surfactant, an alcohol, or any combination thereof. According to yet other embodiments, the surfactant may consist essentially of an alkyl ether sulfate, an ethoxylated surfactant, a lauryl surfactant, an alcohol, or any combination thereof.

Referring now to the second step 120, according to still other embodiments, pre-foam mixture may include a particular surfactant content, where the surfactant content is equal to the content of the surfactant in the pre-foam mixture in weight percent (wt. %) for a total weight of the pre-foam mixture. For example, the pre-foam mixture may include a surfactant content of at least about 0.10 wt. % for a total weight of the stucco-based slurry composition, such as at least about 0.20 wt. % or at least about 0.30 wt. % or at least about 0.40 wt. % or at least about 0.50 wt. % or at least about 0.60 wt. % or at least about 0.70 wt. % or even at least about 0.80 wt. %. According to still other embodiments, the stucco-based slurry composition may include a surfactant content of not greater than about 2.0 wt. % for a total weight of the stucco-based slurry composition, such as not greater than about 1.90 wt. % or not greater than about 1.8 wt. % or not greater than about 1.7 wt. % or not greater than about 1.6 wt. % or not greater than about 1.5 wt. % or not greater than about 1.4 wt. % or not greater than about 1.3 wt. % or not greater than about 1.2 wt. % or even not greater than about 1.1 wt. %. It will be appreciated that the surfactant content in the pre-foam mixture may be within a range between any of the minimum and maximum values noted above. It will be further appreciated that the surfactant content in the pre-foam mixture may be any value between any of the minimum and maximum values noted above.

According to yet other embodiments, the pre-foam mixture may further include a crosslinker component. According to certain embodiments, the crosslinker component may include sodium trimetaphosphate (STMP). According to other embodiments, the crosslinker component may consist essentially of sodium trimetaphosphate (STMP).

According to still other embodiments, pre-foam mixture may include a particular crosslinker content, where the crosslinker content is equal to the content of the crosslinker in the pre-foam mixture in weight percent (wt. %) for a total weight of the pre-foam mixture. For example, the pre-foam mixture may include a crosslinker content of at least about 0.005 wt. % for a total weight of the stucco-based slurry composition, such as at least about 0.01 wt. % or at least about 0.05 wt. % or at least about 0.1 wt. % or at least about 0.15 wt. % or at least about 0.2 wt. % or at least about 0.25 wt. % or even at least about 0.30 wt. %. According to still other embodiments, the stucco-based slurry composition may include a crosslinker content of not greater than about 0.5 wt. % for a total weight of the stucco-based slurry composition, such as not greater than about 0.45 wt. % or not greater than about 0.4 wt. % or even not greater than about 0.35 wt. %. It will be appreciated that the crosslinker content in the pre-foam mixture may be within a range between any of the minimum and maximum values noted above. It will be further appreciated that the crosslinker content in the pre-foam mixture may be any value between any of the minimum and maximum values noted above.

Referring now to the forth step 140, according to yet other embodiments, the stucco-based slurry composition may further include a stucco component. According to certain embodiments, the stucco component may include synthetic stucco, natural stucco, recycled stucco, or any combination thereof. According to still other embodiments, the stucco component may consist essentially of synthetic stucco, natural stucco, recycled stucco, or any combination thereof. According to yet other embodiments, the stucco component may be synthetic stucco. According to still other embodiments, the stucco component may be natural stucco. According to other embodiments, the stucco component may be recycled stucco.

According to still other embodiments, the stucco-based slurry composition may include a particular stucco component content, where the stucco component content is equal to the content of the stucco component in the stucco-based slurry composition in weight percent (wt. %) for a total weight of the stucco-based slurry composition. For example, the stucco-based slurry composition may include a stucco component content of at least about 10 wt. % for a total weight of the stucco-based slurry composition, such as at least about 15 wt. % or at least about 20 wt. % or at least about 25 wt. % or at least about 30 wt. % or at least about 35 wt. % or at least about 40 wt. % or even at least about 45 wt. %. According to still other embodiments, the stucco-based slurry composition may include a stucco component content of not greater than about 95 wt. % for a total weight of the stucco-based slurry composition, such as not greater than about 90 wt. % or not greater than about 85 wt. % or not greater than about 80 wt. % or not greater than about 75 wt. % or not greater than about 70 wt. % or not greater than about 65 wt. % or not greater than about 60 wt. % or even not greater than about 55 wt. %. It will be appreciated that the stucco component content in the stucco-based slurry composition may be within a range between any of the minimum and maximum values noted above. It will be further appreciated that the stucco component content in the stucco-based slurry composition may be any value between any of the minimum and maximum values noted above.

According to yet other embodiments, the stucco-based slurry composition may further include a reinforcement component. According to certain embodiments, the reinforcement component may include glass fibers. According to still other embodiments, the reinforcement component may consist essentially of glass fibers.

According to still other embodiments, the stucco-based slurry composition may include a particular reinforcement component content, where the reinforcement component content is equal to the content of the reinforcement component in the stucco-based slurry composition in weight percent (wt. %) relative to the total weight of the stucco component in the stucco-based slurry composition. For example, the stucco-based slurry composition may include a reinforcement component content of at least about 0.03 wt. % relative to the total weight of the stucco component in the stucco-based slurry composition, such as at least about 0.05 wt. % or at least about 0.1 wt. % or at least about 0.5 wt. % or at least about 1.0 wt. % or at least about 1.5 wt. % or at least about 2.0 wt. % or even at least about 2.5 wt. %. According to still other embodiments, the stucco-based slurry composition may include a reinforcement component content of not greater than about 10 wt. % for a total weight of the stucco-based slurry composition, such as not greater than about 9.5 wt. % or not greater than about 8.0 wt. % or not greater than about 8.5 wt. % or not greater than about 8.0 wt. % or not greater than about 7.5 wt. % or not greater than about 7.0 wt. % or not greater than about 6.5 wt. % or not greater than about 6.0 wt. % or even not greater than about 5.5 wt. %. It will be appreciated that the reinforcement component content in the stucco-based slurry composition may be within a range between any of the minimum and maximum values noted above. It will be further appreciated that the reinforcement component content in the stucco-based slurry composition may be any value between any of the minimum and maximum values noted above.

According to yet other embodiments, the stucco-based slurry composition may further include an accelerator component. According to certain embodiments, the accelerator component may include a heat-resistant gypsum accelerator. According to still other embodiments, the accelerator component may consist essentially of a heat-resistant gypsum accelerator. According to still other embodiments, the heat-resistant gypsum accelerator may be in a liquid form. According to yet other embodiments, the heat-resistant gypsum accelerator may be in a solid form.

According to still other embodiments, the stucco-based slurry composition may include a particular accelerator component content, where the accelerator component content is equal to the content of the accelerator component in the stucco-based slurry composition in weight percent (wt. %) relative to the total weight of the stucco component in the stucco-based slurry composition. For example, the stucco-based slurry composition may include an accelerator component content of at least about 0.1 wt. % relative to the total weight of the stucco component in the stucco-based slurry composition, such as at least about 0.25 wt. % or at least about 0.5 wt. % or at least about 0.75 wt. % or at least about 1.0 wt. % or at least about 1.5 wt. % or even at least about 2.0 wt. %. According to still other embodiments, the stucco-based slurry composition may include an accelerator component content of not greater than about 5.0 wt. % for a total weight of the stucco-based slurry composition, such as not greater than about 4.5 wt. % or not greater than about 4.0 wt. % or not greater than about 3.5 wt. % or not greater than about 3.0 wt. % or even not greater than about 2.5 wt. %. It will be appreciated that the accelerator component content in the stucco-based slurry composition may be within a range between any of the minimum and maximum values noted above. It will be further appreciated that the accelerator component content in the stucco-based slurry composition may be any value between any of the minimum and maximum values noted above.

According to yet other embodiments, the stucco-based slurry composition may further include a guar gum component. According to certain embodiments, the guar gum component may include a native guar gum, a chemically modified guar gum, or any combination thereof. According to still other embodiments, the guar gum component may consist essentially of a native guar gum, a chemically modified guar gum, or any combination thereof a heat-resistant gypsum accelerator.

According to yet other embodiments, the stucco-based slurry composition may further include a siloxane component. According to certain embodiments, the siloxane component may include polymethylhydrosiloxane (PMHS), polydimethylsiloxane (PDMS), a silanol containing siloxane, or any combination thereof. According to still other embodiments, the siloxane component may consist essentially of polymethylhydrosiloxane (PMHS), polydimethylsiloxane (PDMS), a silanol containing siloxane, or any combination thereof.

According to still other embodiments, the stucco-based slurry composition may include a particular siloxane component content, where the siloxane component content is equal to the content of the siloxane component in the stucco-based slurry composition in weight percent (wt. %) relative to the total weight of the stucco component in the stucco-based slurry composition. For example, the stucco-based slurry composition may include a siloxane component content of at least about 0.01 wt. % relative to the total weight of the stucco component in the stucco-based slurry composition, such as at least about 0.1 wt. % or at least about 0.2 wt. % or at least about 0.3 wt. % or at least about 0.4 wt. % or at least about 0.5 wt. % or at least about 0.6 wt. % or even at least about 0.7 wt. %. According to still other embodiments, the stucco-based slurry composition may include an siloxane component content of not greater than about 2.0 wt. % for a total weight of the stucco-based slurry composition, such as not greater than about 1.9 wt. % or not greater than about 1.8 wt. % or not greater than about 1.7 wt. % or not greater than about 1.6 wt. % or even not greater than about 1.5 wt. %. It will be appreciated that the siloxane component content in the stucco-based slurry composition may be within a range between any of the minimum and maximum values noted above. It will be further appreciated that the siloxane component content in the stucco-based slurry composition may be any value between any of the minimum and maximum values noted above.

According to yet other embodiments, the stucco-based slurry composition may further include a dispersant component. According to certain embodiments, the dispersant component may include polynaphthalene sulfonate, ligno sulfonate, polyaryl ether poly carboxylate, or any combination thereof. According to still other embodiments, the dispersant component may consist essentially of polynaphthalene sulfonate, ligno sulfonate, polyaryl ether poly carboxylate, or any combination thereof.

According to still other embodiments, the stucco-based slurry composition may include a particular dispersant component content, where the dispersant component content is equal to the content of the dispersant component in the stucco-based slurry composition in weight percent (wt. %) relative to the total weight of the stucco component in the stucco-based slurry composition. For example, the stucco-based slurry composition may include a dispersant component content of at least about 0.1 wt. % relative to the total weight of the stucco component in the stucco-based slurry composition, such as at least about 0.2 wt. % or at least about 0.3 wt. % or even at least about 0.4 wt. %. According to still other embodiments, the stucco-based slurry composition may include an dispersant component content of not greater than about 1.0 wt. % for a total weight of the stucco-based slurry composition, such as not greater than about 0.9 wt. % or not greater than about 0.8 wt. % or not greater than about 0.7 wt. % or not greater than about 0.6 wt. % or even not greater than about 0.5 wt. %. It will be appreciated that the dispersant component content in the stucco-based slurry composition may be within a range between any of the minimum and maximum values noted above. It will be further appreciated that the dispersant component content in the stucco-based slurry composition may be any value between any of the minimum and maximum values noted above.

According to yet other embodiments, the stucco-based slurry composition may further include a water component.

According to still other embodiments, the stucco-based slurry composition may include a particular water component content, where the water component content is equal to the content of the water component in the stucco-based slurry composition in weight percent (wt. %) relative to the total weight of the stucco component in the stucco-based slurry composition. For example, the stucco-based slurry composition may include a water component content of at least about 50 wt. % relative to the total weight of the stucco component in the stucco-based slurry composition, such as at least about 53 wt. % or at least about 55 wt. % or at least about 58 wt. % or at least about 60 wt. % or even at least about 63 wt. %. According to still other embodiments, the stucco-based slurry composition may include a water component content of not greater than about 90 wt. % for a total weight of the stucco-based slurry composition, such as not greater than about 88 wt. % or not greater than about 85 wt. % or not greater than about 83 wt. % or not greater than about 80 wt. % or not greater than about 78 wt. % or even not greater than about 75 wt. %. It will be appreciated that the water component content in the stucco-based slurry composition may be within a range between any of the minimum and maximum values noted above. It will be further appreciated that the water component content in the stucco-based slurry composition may be any value between any of the minimum and maximum values noted above.

According to certain embodiments, the gypsum-based construction material forming composition may have a particular pH. For purposes of embodiments described herein, the pH of a particular component measured using a pH meter with a 4% solution of the PVOH. According to particular embodiments, the gypsum-based construction material forming composition may have a pH of at least about 7.6, such as at least about 7.7 or at least about 7.8 or at least about 7.9 or at least about 8.0 or even at least about 8.1. According to still other embodiments, the gypsum-based construction material forming composition may have a pH of not greater than about 9.9, such as not greater thana about 9.8 or not greater than about 9.7 or not greater than about 9.6 or not greater than about 9.5 or even not greater than about 9.4. It will be appreciated that the gypsum-based construction material forming composition may have a pH within a range between any of the minimum and maximum values noted above. It will be further appreciated that the gypsum-based construction material forming composition may have a pH of any value between any of the minimum and maximum values noted above.

Referring now to the fifth step 150 of forming the gypsum-based construction material forming composition into a gypsum-based construction material forming the gypsum-based construction material forming composition into a gypsum-based construction material, according to certain embodiments, the aforementioned gypsum-based construction material forming composition or compositions may be deposited to form a gypsum preform of a gypsum-based construction material preform. According to still other embodiments, the gypsum preform can then be dried to make a gypsum core, converting the stucco component into a gypsum component.

According to still other embodiments, the aforementioned gypsum-based construction material forming composition or compositions may be cast to form a gypsum-based construction material such as a panel, a board, walls, plinths, slabs, columns, sheets, casts, or shafts.

According to still other embodiments, the gypsum core may include a particular gypsum component content, where the gypsum component content is equal to the content of the gypsum component in the gypsum core in weight percent (wt. %) for a total weight of the gypsum core. For example, the gypsum core may include a gypsum component content of at least about 10 wt. % for a total weight of the gypsum core, such as at least about 15 wt. % or at least about 20 wt. % or at least about 25 wt. % or at least about 30 wt. % or at least about 35 wt. % or at least about 40 wt. % or even at least about 45 wt. %. According to still other embodiments, the gypsum core may include a gypsum component content of not greater than about 95 wt. % for a total weight of the gypsum core, such as not greater than about 90 wt. % or not greater than about 85 wt. % or not greater than about 80 wt. % or not greater than about 75 wt. % or not greater than about 70 wt. % or not greater than about 65 wt. % or not greater than about 60 wt. % or even not greater than about 55 wt. %. It will be appreciated that the gypsum component content in the gypsum core may be within a range between any of the minimum and maximum values noted above. It will be further appreciated that the gypsum component content in the gypsum core may be any value between any of the minimum and maximum values noted above.

According to yet other embodiments, the gypsum core may further include a reinforcement component. According to certain embodiments, the reinforcement component may include glass fibers. According to still other embodiments, the reinforcement component may consist essentially of glass fibers.

According to still other embodiments, the gypsum core may include a particular reinforcement component content, where the reinforcement component content is equal to the content of the reinforcement component in the gypsum core in weight percent (wt. %) relative to the total weight of the gypsum component in the gypsum core. For example, the gypsum core may include a reinforcement component content of at least about 0.03 wt. % relative to the total weight of the gypsum component in the gypsum core, such as at least about 0.05 wt. % or at least about 0.1 wt. % or at least about 0.5 wt. % or at least about 1.0 wt. % or at least about 1.5 wt. % or at least about 2.0 wt. % or even at least about 2.5 wt. %. According to still other embodiments, the gypsum core may include a reinforcement component content of not greater than about 10 wt. % for a total weight of the gypsum core, such as not greater than about 9.5 wt. % or not greater than about 8.0 wt. % or not greater than about 8.5 wt. % or not greater than about 8.0 wt. % or not greater than about 7.5 wt. % or not greater than about 7.0 wt. % or not greater than about 6.5 wt. % or not greater than about 6.0 wt. % or even not greater than about 5.5 wt. %. It will be appreciated that the reinforcement component content in the gypsum core may be within a range between any of the minimum and maximum values noted above. It will be further appreciated that the reinforcement component content in the gypsum core may be any value between any of the minimum and maximum values noted above.

According to still other embodiments, the gypsum core may include a particular dispersant component content, where the dispersant component content is equal to the content of the dispersant component in the gypsum core in weight percent (wt. %) relative to the total weight of the gypsum component in the gypsum core. For example, the gypsum core may include a dispersant component content of at least about 0.1 wt. % relative to the total weight of the gypsum component in the gypsum core, such as at least about 0.15 wt. % or at least about 0.20 wt. % or at least about 0.25 wt. % or at least about 0.30 wt. % or at least about 0.35 wt. % or at least about 0.40 wt. % or even at least about 0.45 wt. %. According to still other embodiments, the gypsum core may include a dispersant component content of not greater than about 1.0 wt. % for a total weight of the gypsum core, such as not greater than about 0.95 wt. % or not greater than about 0.90 wt. % or not greater than about 0.85 wt. % or not greater than about 0.80 wt. % or not greater than about 0.75 wt. % or not greater than about 0.70 wt. % or not greater than about 0.65 wt. % or not greater than about 0.60 wt. % or even not greater than about 0.55 wt. %. It will be appreciated that the dispersant component content in the gypsum core may be within a range between any of the minimum and maximum values noted above. It will be further appreciated that the dispersant component content in the gypsum core may be any value between any of the minimum and maximum values noted above.

According to still other embodiments, the gypsum core may have a particular bubble structure as measured and analyzed according to a gypsum core bubble analysis method described by U.S. patent application Ser. No. 18/481,315, incorporated herein by reference in its entirety.

For purposes of embodiments described herein, core bubble analysis method is conducted according to the following protocol: 1) provide a sample of the gypsum core to be analyzed, 2) form a cut surface that extends across the sample of the gypsum core, 3) capture an image of a region of the cut surface, 4) capture a 2D image of the region of the cut surface, 5) analyze the image to identify bubbles having a diameter of at least 50 micrometers intersecting the cut surface, 6) determine, from the identified bubbles, a set of contacting bubbles each of which is in contact with at least one other bubble, 7) determine, based on the set of contacting bubbles, a measure of bubble contact in the gypsum core based on the identified bubbles in the image; and based on the measure of bubble contact, modifying a first operating parameter of the plurality of operating parameters for forming the porous slurry layer on the receiving surface.

It will be appreciated that the term “bubble” as used herein refers to an open space within the gypsum core that has an identifiable boundary to distinguish the area or volume of the bubble from the gypsum material and from neighboring bubbles. Thus, an open space within the gypsum core may be formed by a single bubble or may be formed by two or more bubbles that are in contact. Bubbles in contact with one another may have started to coalesce but still be identifiable as individual elements based on the shape of the open space within the gypsum. Accordingly, within a gypsum core there may be many bubbles, some of which are in contact with one another.

According to particular embodiments, the gypsum core as described herein may have a particular core bubble median size (D₅₀) as measured using the gypsum core bubble analysis method described herein. It will be appreciated that the core bubble median size (D₅₀) may be defined as the average bubble diameter (i.e., 50% of the bubble diameters are smaller than the value) and is measured according to the gypsum core bubble analysis method described herein. According to certain embodiments, the gypsum core may have a core bubble median size (D₅₀) of at least about 80 microns, such as, at least about 90 microns or at least about 100 microns or at least about 110 microns or at least about 120 microns or at least about 130 microns or at least about 140 microns or at least about 150 microns or at least about 160 microns or at least about 170 microns or at least about 180 microns or at least about 190 microns or at least about 200 microns or at least about 200 microns or at least about 210 microns or even at least about 220 microns. According to still other embodiments, the gypsum core may have a core bubble median size (D₅₀) of not greater than about 800 microns, such as, not greater than about 790 microns or not greater than about 780 microns or not greater than about 770 microns or not greater than about 760 microns or not greater than about 750 microns or not greater than about 740 microns or not greater than about 730 microns or not greater than about 720 microns or not greater than about 710 microns or not greater than about 700 microns or not greater than about 690 microns or not greater than about 680 microns or not greater than about 670 microns or not greater than about 660 microns or even not greater than about 650 microns. It will be appreciated that the gypsum core may have a core bubble median size (D₅₀) within a range between any of the minimum and maximum values noted above. It will be further appreciated that the gypsum core may have a core bubble median size (D₅₀) of any value between any of the minimum and maximum values noted above.

According to particular embodiments, the gypsum core as described herein may have a particular contacting bubble surface percentage (%) as measured using the gypsum core bubble analysis method described herein. It will be appreciated that the contacting bubble surface percentage (%) may be defined as a percentage of bubble within the gypsum core that are in contact with at least one other bubble within the gypsum core and is measured according to the gypsum core bubble analysis method described herein. According to certain embodiments, the gypsum core may have a core bubble median size (D₅₀) of at least about 50%, such as, not greater than about 48% or not greater than about 45% or not greater than about 43% or not greater than about 40% or not greater than about 35% or not greater than about 33% or not greater than about 30% or not greater than about 28% or even not greater than about 25%. It will be appreciated that the gypsum core may have a contacting bubble surface percentage (%) within a range between any of the values noted above. It will be further appreciated that the gypsum core may have a contacting bubble surface percentage (%) of any value between any of the values noted above.

According to yet other embodiments, the gypsum core may have a particular thickness. For example, the gypsum core may have a thickness of at least about 5.0 mm, such as at least about 5.5 mm or at least about 6.0 mm or at least about 6.5 mm or at least about 7.0 mm or at least about 7.5 mm or at least about 8.0 mm or at least about 8.5 mm or at least about 9.0 mm or even at least about 9.5 mm. According to still other embodiments, the gypsum core may have a thickness of not greater than about 30 mm, such as not greater than about 29.0 mm or not greater than about 28.0 mm or not greater than about 27.0 mm or not greater than about 26.0 mm or not greater than about 25.0 mm or not greater than about 24.0 mm or not greater than about 23.0 mm or not greater than about 22.0 mm or not greater than about 21.0 mm or even not greater than about 20.0 mm. It will be appreciated that the gypsum core may have a thickness within a range between any of the minimum and maximum values noted above. It will be further appreciated that the gypsum core may have a thickness of any value between any of the minimum and maximum values noted above.

According to yet other embodiments, the gypsum core may have a particular surface density. For example, the gypsum core may have a surface density of at least about 1150 lbs./msf, such as at least about 1200 lbs./msf or at least about 1250 lbs./msf or at least about 1300 lbs./msf or at least about 1350 lbs./msf or at least about 1400 lbs./msf or at least about 1450 lbs./msf or at least about 1500 lbs./msf or at least about 1550 lbs./msf or at least about 1600 lbs./msf or even at least about 1650 lbs./msf. According to still other embodiments, the gypsum core may have a surface density of not greater than about 2550 lbs./msf, such as not greater than about 2500 lbs./msf or not greater than about 2450 lbs./msf or not greater than about 2400 lbs./msf or not greater than about 2350 lbs./msf or not greater than about 2300 lbs./msf or not greater than about 2250 lbs./msf or not greater than about 2200 lbs./msf or not greater than about 2150 lbs./msf or not greater than about 2100 lbs./msf or even not greater than about 2050 lbs./msf. It will be appreciated that the gypsum core may have a surface density within a range between any of the minimum and maximum values noted above. It will be further appreciated that the gypsum core may have a surface density of any value between any of the minimum and maximum values noted above.

According to yet other embodiments, the gypsum-based construction material may have a particular thickness. For example, the gypsum-based construction material may have a thickness of at least about 5.0 mm, such as at least about 6.0 mm or at least about 7.0 mm or at least about 8.0 mm or at least about 9.0 mm or at least about 10.0 mm or at least about 11.0 mm or at least about 12.0 mm or at least about 13.0 mm or at least about 14.0 mm or even at least about 15.0 mm. According to still other embodiments, the gypsum-based construction material may have a thickness of not greater than about 30 mm, such as not greater than about 29.0 mm or not greater than about 28.0 mm or not greater than about 27.0 mm or not greater than about 26.0 mm or not greater than about 25.0 mm or not greater than about 24.0 mm or not greater than about 23.0 mm or not greater than about 22.0 mm or not greater than about 21.0 mm or even not greater than about 20.0 mm. It will be appreciated that the gypsum-based construction material may have a thickness within a range between any of the minimum and maximum values noted above. It will be further appreciated that the gypsum-based construction material may have a thickness of any value between any of the minimum and maximum values noted above.

According to yet other embodiments, the gypsum-based construction material may have a particular surface density. For example, the gypsum-based construction material may have a surface density of at least about 1150 lbs./msf, such as at least about 1200 lbs./msf or at least about 1250 lbs./msf or at least about 1300 lbs./msf or at least about 1350 lbs./msf or at least about 1400 lbs./msf or at least about 1450 lbs./msf or at least about 1500 lbs./msf or at least about 1550 lbs./msf or at least about 1600 lbs./msf or even at least about 1650 lbs./msf. According to still other embodiments, the gypsum-based construction material may have a surface density of not greater than about 2550 lbs./msf, such as not greater than about 2500 lbs./msf or not greater than about 2450 lbs./msf or not greater than about 2400 lbs./msf or not greater than about 2350 lbs./msf or not greater than about 2300 lbs./msf or not greater than about 2250 lbs./msf or not greater than about 2200 lbs./msf or not greater than about 2150 lbs./msf or not greater than about 2100 lbs./msf or even not greater than about 2050 lbs./msf. It will be appreciated that the gypsum-based construction material may have a surface density within a range between any of the minimum and maximum values noted above. It will be further appreciated that the gypsum-based construction material may have a surface density of any value between any of the minimum and maximum values noted above.

According to still other embodiments, where the gypsum core has a thickness of not greater than about 20 mm, the gypsum core may have a particular core hardness. For purposes of embodiments described herein, core hardness is measured according to ASTM C473 with values normalized with respect to a density corresponding to 1500 lbs/msf at 0.5 inch thickness. According to particular embodiments, the gypsum core may have a core hardness of at least about 60 N, such as at least about 65 N or at least about 70 N or at least about 75 N or at least about 80 N or at least about 85 N or at least about 90 N or at least about 95 N or at least about 100 N or even at least about 105 N. According to still other embodiments, the gypsum core may have a core hardness of not greater than about 150 N, such as not greater than about 145 N or not greater than about 140 N or not greater than about 135 N or even not greater than about 130 N. It will be appreciated that the gypsum core may have a core hardness within a range between any of the minimum and maximum values noted above. It will be further appreciated that the gypsum core may have a core hardness of any value between any of the minimum and maximum values noted above.

According to still other embodiments, the gypsum core may have a particular nail pull resistance. For purposes of embodiments described herein, nail pull resistance is measured according to ASTM C473 with values normalized with respect to a density corresponding to 1500 lbs/msf at 0.5 inch thickness. According to particular embodiments, the gypsum core may have a nail pull of at least about 60 lbf, such as at least about 65 lbf or at least about 70 lbf or at least about 75 lbf or at least about 80 lbf or at least about 85 lbf or even at least about 900 lbf. According to still other embodiments, the gypsum core may have a nail pull of not greater than about 120 lbf, such as not greater than about 115 lbf or not greater than about 110 lbf or even not greater than about 105 lbf. It will be appreciated that the gypsum core may have a nail pull within a range between any of the minimum and maximum values noted above. It will be further appreciated that the gypsum core may have a nail pull of any value between any of the minimum and maximum values noted above.

According to certain embodiments, the gypsum core may have a particular pH. For purposes of embodiments described herein, the pH of a particular component measured using a pH meter with a 4% solution of the PVOH. According to particular embodiments, the gypsum core may have a pH of at least about 7.6, such as at least about 7.7 or at least about 7.8 or at least about 7.9 or at least about 8.0 or even at least about 8.1. According to still other embodiments, the gypsum core may have a pH of not greater than about 9.9, such as not greater thana about 9.8 or not greater than about 9.7 or not greater than about 9.6 or not greater than about 9.5 or even not greater than about 9.4. It will be appreciated that the gypsum core may have a pH within a range between any of the minimum and maximum values noted above. It will be further appreciated that the gypsum core may have a pH of any value between any of the minimum and maximum values noted above.

According to certain embodiments, the gypsum-based construction material may have a particular pH. For purposes of embodiments described herein, the molecular weight of a particular component is defined as the sum of the atomic masses of all atoms in the molecule and is measured using size exclusion chromatography (SEC). According to particular embodiments, the gypsum-based construction material may have a pH of at least about 7.6, such as at least about 7.7 or at least about 7.8 or at least about 7.9 or at least about 8.0 or even at least about 8.1. According to still other embodiments, the gypsum-based construction material may have a pH of not greater than about 9.9, such as not greater thana about 9.8 or not greater than about 9.7 or not greater than about 9.6 or not greater than about 9.5 or even not greater than about 9.4. It will be appreciated that the gypsum-based construction material may have a pH within a range between any of the minimum and maximum values noted above. It will be further appreciated that the gypsum-based construction material may have a pH of any value between any of the minimum and maximum values noted above.

In an embodiment, the gypsum-based construction material can further include at least one liner. The liner may be a particular material that may facilitate improved performance and/or manufacturing of the gypsum-based construction material. In an embodiment, the liner may comprise a paper liner, a glass mat liner, or any combination thereof.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.
Embodiment 1. A method of forming a gypsum-based construction material, wherein the method comprises: providing a stucco-based slurry composition, a pre-formed polymer reinforced component, and a surfactant, wherein the pre-formed polymer reinforced polymer component comprises a partially hydrolyzed polyvinyl alcohol (PVOH) at a content of not greater than about 10 wt. % for a total weight of the stucco-based slurry composition, forming a pre-foam mixture by combining the pre-formed polymer reinforced component with the surfactant, injecting air into the pre-foam mixture to form a polymer reinforced foam component, mixing the polymer reinforced foam component into the stucco-based slurry composition to form a gypsum-based construction material forming composition, and forming the gypsum-based construction material forming composition into a gypsum-based construction material.
Embodiment 2. A gypsum-based construction material formed from a stucco-based slurry composition, and a polymer reinforced foam component, wherein the polymer reinforced foam component comprises a partially hydrolyzed polyvinyl alcohol (PVOH) at a content of not greater than about 10 wt. % for a total weight of the stucco-based slurry composition, and wherein the gypsum-based construction material comprises a gypsum core having a nail pull resistance of at least about 60 lbf.
Embodiment 3. A gypsum-based construction material formed from a stucco-based slurry composition, and a polymer reinforced foam component, wherein the polymer reinforced foam component comprises a partially hydrolyzed polyvinyl alcohol (PVOH) at a content of not greater than about 10 wt. % for a total weight of the stucco-based slurry composition, and wherein the gypsum-based construction material comprises a gypsum core having a core hardness of at least about 60 N.
Embodiment 4. A gypsum-based construction material comprising a gypsum core, wherein the gypsum core comprises: a gypsum component, and a polymer reinforced foam component comprising a partially hydrolyzed polyvinyl alcohol (PVOH), wherein the gypsum-based construction material comprises a nail pull resistance of at least about 60 lbf.
Embodiment 5. A gypsum-based construction material comprising a gypsum core, wherein the gypsum core comprises: a gypsum component, and a polymer reinforced foam component comprising a partially hydrolyzed polyvinyl alcohol (PVOH), wherein the gypsum-based construction material comprises a core hardness of at least about 60 N.
Embodiment 6. A gypsum-based construction material comprising a gypsum core, wherein the gypsum core comprises: a gypsum component, a polymer reinforced foam component comprising a partially hydrolyzed polyvinyl alcohol (PVOH), a core bubble median size (D50) of at least about 80 microns and not greater than about 800 microns, a contacting bubble surface percentage of not greater than about 50%, and an average core hardness of at least about 60 N.
Embodiment 7. The method of embodiment 1, wherein the pre-foam mixture further comprises a crosslinker component.
Embodiment 8. The method of embodiment 7, wherein the crosslinker component comprises sodium trimetaphosphate (STMP).
Embodiment 9. The method of embodiment 7, wherein the pre-foam mixture comprises a crosslinker component content of at least about 0.005 wt. % for a total weight of the pre-foam mixture.
Embodiment 10. The method of embodiment 7, wherein the pre-foam mixture comprises a crosslinker component content of not greater than about at least about 0.5 wt. % for a total weight of the pre-foam mixture.
Embodiment 11. The method of embodiment 1, wherein the surfactant component comprises of alkyl ether sulfate, ethoxylated surfactant or lauryl surfactants, alcohol, and combination thereof.
Embodiment 12. The method of embodiment 1, wherein the pre-foam mixture comprises a surfactant component content of at least about 0.1 wt. % for a total weight of the pre-foam mixture.
Embodiment 13. The method of embodiment 1, wherein the pre-foam mixture comprises a surfactant component content of not greater than about at least about 2.0 wt. % for a total weight of the pre-foam mixture.
Embodiment 14. The method or gypsum-based construction material of any one of embodiments 1, 4, and 5, wherein the partially hydrolyzed PVOH comprises a degree of hydrolysis of at least about 85%.
Embodiment 15. The method or gypsum-based construction material of any one of embodiments 1, 2, 3, 4, 5, and 6, wherein the partially hydrolyzed PVOH comprises a degree of hydrolysis of not greater than about 95%.
Embodiment 16. The method or gypsum-based construction material of any one of embodiments 1, 2, 3, 4, 5, and 6, wherein the partially hydrolyzed PVOH comprises a purity of at least about 70.
Embodiment 17. The method or gypsum-based construction material of any one of embodiments 1, 2, 3, 4, 5, and 6, wherein the partially hydrolyzed PVOH comprises a purity of not greater than about 100.
Embodiment 18. The method or gypsum-based construction material of any one of embodiments 1, 2, 3, 4, 5, and 6, wherein the partially hydrolyzed PVOH comprises a pH of at least about 5.5.
Embodiment 19. The method or gypsum-based construction material of any one of embodiments 1, 2, 3, 4, 5, and 6, wherein the partially hydrolyzed PVOH comprises a pH of not greater than about 7.5.
Embodiment 20. The method or gypsum-based construction material of any one of embodiments 1, 2, 3, 4, 5, and 6, wherein the partially hydrolyzed PVOH comprises a molecular weight of at least about 20K.
Embodiment 21. The method or gypsum-based construction material of any one of embodiments 1, 2, 3, 4, 5, and 6, wherein the partially hydrolyzed PVOH comprises a molecular weight of not greater than about 80K.
Embodiment 22. The method or gypsum-based construction material of any one of embodiments 1, 2, 3, 4, 5, and 6, wherein the gypsum-based construction material comprises a nail pull resistance of at least about 60 lbf.
Embodiment 23. The method or gypsum-based construction material of any one of embodiments 1, 2, 3, 4, 5, and 6, wherein the gypsum-based construction material comprises a core hardness of at least about 60 N.
Embodiment 24. The method or gypsum-based construction material of any one of embodiments 1, 2, 3, 4, 5, and 6, wherein the gypsum core comprises a core bubble median size (D50) of at least about 80 microns, and not greater than about 800 microns.
Embodiment 25. The method of embodiment 1, wherein forming the gypsum-based construction material forming composition into the gypsum-based construction material comprises: depositing the gypsum-based construction material forming composition to form a gypsum preform of the gypsum-based construction material forming composition, and drying the gypsum preform of the gypsum-based construction material forming composition to form a gypsum core.
Embodiment 26. The method or gypsum-based construction material of any one of embodiments 1, 2, 3, 4, 5, and 6, wherein the construction material has a thickness of at least 5.0 mm.
Embodiment 27. The method or gypsum-based construction material of any one of embodiments 1, 2, 3, 4, 5, and 6, wherein the construction material has a thickness of less than 30 mm.
Embodiment 28. The method or gypsum-based construction material of any one of embodiments 1, 2, 3, 4, 5, and 6, wherein the construction material has a density of at least 1150 lbs/msf.
Embodiment 29. The method or gypsum-based construction material of any one of embodiments 1, 2, 3, 4, 5, and 6, wherein the construction material has a density of less than 2550 lbs/msf.
Embodiment 30. The method or gypsum-based construction material of any one of embodiments 1, 2, 3, 4, 5, and 6, wherein the gypsum-based construction material forming composition comprises a pH of at least about 7.6.
Embodiment 31. The method or gypsum-based construction material of any one of embodiments 1, 2, 3, 4, 5, and 6, wherein the gypsum-based construction material forming composition comprises a pH of not greater than about 9.9.
Embodiment 32. The method or gypsum-based construction material of any one of embodiments 1, 2, 3, 4, 5, and 6, wherein the gypsum-based construction material comprises a pH of at least about 6.
Embodiment 33. The method or gypsum-based construction material of any one of embodiments 1, 2, 3, 4, 5, and 6, wherein the gypsum-based construction material comprises a pH of not greater than about 9.9.
Embodiment 34. The method or gypsum-based construction material of any one of embodiments 1, 2, 3, 4, 5, and 6, wherein the gypsum-based construction material exhibits moisture resistance.
Embodiment 35. The method or gypsum-based construction material of any one of embodiments 1, 2, 3, 4, 5, and 6, wherein the stucco-based slurry composition comprises a stucco component.
Embodiment 36. The method or gypsum-based construction material of embodiment 35, wherein the stucco-based slurry composition comprises the stucco component at a content of at least about 10 wt. % for a total weight of the stucco-based slurry composition.
Embodiment 37. The method or gypsum-based construction material of embodiment 35, wherein the stucco-based slurry composition comprises the stucco component at a content of not greater than about 95 wt. % for a total weight of the stucco-based slurry composition.
Embodiment 38. The method or gypsum-based construction material of embodiment 35, wherein the stucco component comprises of synthetic, natural, or recycled stucco or the combination thereof.
Embodiment 39. The method or gypsum-based construction material of embodiment 35, wherein the stucco-based slurry composition comprises a reinforcement component.
Embodiment 40. The method or gypsum-based construction material of embodiment 39, wherein the reinforcement component comprises glass fiber.
Embodiment 41. The method or gypsum-based construction material of embodiment 39, wherein the stucco-based slurry composition comprises a reinforcement content of at least about 0.03 wt. % relative to the content of stucco component.
Embodiment 42. The method or gypsum-based construction material of embodiment 39, wherein the stucco-based slurry composition comprises a reinforcement content of not greater than about 10 wt. % relative to the content of stucco component.
Embodiment 43. The method or gypsum-based construction material of embodiment 35, wherein the stucco-based slurry composition comprises an accelerator component.
Embodiment 44. The method or gypsum-based construction material of embodiment 43, wherein the accelerator component comprises a heat-resistant gypsum accelerator (both in solid and liquid form).
Embodiment 45. The method or gypsum-based construction material of embodiment 43, wherein the stucco-based slurry composition comprises the accelerator component at a content of at least about 0.1 wt. % relative to the content of the stucco component.
Embodiment 46. The method or gypsum-based construction material of embodiment 43, wherein the stucco-based slurry composition comprises the accelerator component at a content of not greater than about 5.0 wt. % relative to the content of the stucco component.
Embodiment 47. The method or gypsum-based construction material of embodiment 35, wherein the stucco-based slurry composition comprises a guar gum component.
Embodiment 48. The method or gypsum-based construction material of embodiment 47, wherein the guar gum component comprises a native guar gum, a chemically modified guar gum, or any combination thereof.
Embodiment 49. The method or gypsum-based construction material of embodiment 35, wherein the stucco-based slurry composition comprises a siloxane.
Embodiment 50. The method or gypsum-based construction material of embodiment 49, wherein the siloxane comprises PMHS, PDMS, a silanol containing siloxane, or any combination thereof.
Embodiment 51. The method or gypsum-based construction material of embodiment 49, wherein the stucco-based slurry composition comprises a siloxane content of at least about 0.01 wt. % relative to the content of the stucco component.
Embodiment 52. The method or gypsum-based construction material of embodiment 49, wherein the stucco-based slurry composition comprises a siloxane content of not greater than about 2.0 wt. % relative to the content of the stucco component.
Embodiment 53. The method or gypsum-based construction material of embodiment 35, wherein the stucco-based slurry composition comprises a dispersant.
Embodiment 54. The method or gypsum-based construction material of embodiment 53, wherein the precursor dispersant component comprises polynaphthalene sulfonate, ligno sulfonate, polyaryl ether poly carboxylate or any combination thereof.
Embodiment 55. The method or gypsum-based construction material of embodiment 53, wherein the stucco-based slurry composition comprises the dispersant component at a content of at least about 0.1 wt. % relative to the content of the stucco component.
Embodiment 56. The method or gypsum-based construction material of embodiment 53, wherein the stucco-based slurry composition comprises the dispersant component at a content of not greater than about 1 wt. % relative to the content of the precursor stucco component.
Embodiment 57. The method or gypsum-based construction material of embodiment 35, wherein the stucco-based slurry composition comprises a water component.
Embodiment 58. The method or gypsum-based construction material of embodiment 57, wherein the stucco-based slurry composition comprises the water component at a content at least 50% relative to the content of the stucco component.
Embodiment 59. The method or gypsum-based construction material of embodiment 57, wherein the stucco-based slurry composition comprises the water component at a content of not greater than 90% relative to the content of the stucco component.

### EXAMPLES

### Example 1

The following non-limiting examples illustrates the embodiments described herein. For purposes of this example, Samples S1 and S2 were formed according to embodiments described herein, and Comparative Samples CS1 and CS2 were formed for comparison to Samples S1 and S2.

Samples S1 and S2 were prepared using a polymer reinforced foam component that includes at least PVOH as described herein. For Sample S1, the polymer reinforced foam component was prepared using 2.5 wt. % PVOH solution in DI water (75 g of PVOH and 2925 g of DI). The PVOH solution was then heated at 40° C. for two hours before adding 29.69 g or surfactant and mixing it with PVOH solution (2939.31 g) to create PVOH foam combo. Sample S1 was prepared by mixing a stucco-based slurry composition with 500 g of stucco, 20 g of 1% retardant in water solution (0.04 wt. % retardant based on the weight of the stucco), 400 g water (80 wt. % based on the weight of the stucco), 3 g acid modified starch (0.6 wt. % based on the weight of the stucco), 2 g of a gypsum accelerator (0.4 wt. % based on the weight of the stucco), 2 g of fluidizer (0.4 wt. % based on the weight of the stucco). The PVOH foam solution was then injected with air into the stucco-based slurry composition to achieve a ½ inches thick board with board surface density target at 1500 lbs/msf. The stucco-based slurry was allowed to set and dried to remove excess water, forming the final gypsum board.

For Sample S2, the polymer reinforced foam component was prepared using 2.5 wt. % PVOH solution in DI water (75 g of PVOH and 2925 g of DI). The PVOH solution was then heated at 40° C. for two hours before adding 29.69 g or surfactant and mixing it with PVOH solution (2939.31 g) to create PVOH foam combo. Then, 9.7 g of STMP was added to the PVOH foam combo to form a PVOH+STMP foam component. Sample S2 was prepared by mixing a stucco-based slurry composition with 500 g of stucco, 20 g of 1% retardant in water solution (0.04 wt. % retardant based on the weight of the stucco), 400 g water (80 wt. % based on the weight of the stucco), 3 g acid modified starch (0.6 wt. % based on the weight of the stucco), 2 g of a gypsum accelerator (0.4 wt. % based on the weight of the stucco), 2 g of fluidizer (0.4 wt. % based on the weight of the stucco). The PVOH+STMP foam component is then injected with air into the stucco-based slurry composition to achieve a ½ inches thick board with board surface density target at 1500 lbs/msf. The stucco-based slurry was allowed to set and dried to remove excess water, forming the final gypsum board.

Comparative sample CS1 was prepared by mixing a stucco-based slurry composition with 500 g of stucco, 20 g of 1% retardant in water solution (0.04 wt. % retardant based on the weight of the stucco), 400 g water (80 wt. % based on the weight of the stucco), 3 g acid modified starch (0.6 wt. % based on the weight of the stucco), 2 g of a gypsum accelerator (0.4 wt. % based on the weight of the stucco), 2 g of fluidizer (0.4 wt. % based on the weight of the stucco). Surfactant solution (1 wt. %) was then injected with air into the stucco-based slurry composition to achieve a ½ inches thick board with board surface density target at 1500 lbs/msf. The stucco-based slurry was allowed to set and dried to remove excess water, forming the final gypsum board.

Comparative Sample CS2 was prepared the same way as Comparative Sample CS1, except that it included the addition of dry PVOH at 2.5 g.

The performance characteristics for Samples S1 and S2 and Comparative Samples CS1 and CS2, including Nail Pull, Core Hardness, and Bubble Median Size were measured as described herein and provided below in Table 1.

TABLE 1
Performance

| | | | | CS2 |
|---|---|---|---|---|
| | S1 | S2 | CS1 | (PVOH |
| | (PVOH | (PVOH & STMP | (No | Added |
| Properties | FOAM) | in FOAM) | PVOH) | Dry) |
| Nail Pull (lbf) | 73.6 | 78.5 | 72.7 | 68.1 |
| Core Hardness (N) | 78.6 | 83.8 | 73.8 | 62.2 |
| Bubble Median | 116 | 124 | 132 | 153 |
| Size -D50 (microns) | | | | |

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and components to problems have been described above with regard to specific embodiments. However, the benefits, advantages, components to problems, and any feature(s) that may cause any benefit, advantage, or component to occur or become more pronounced are not to be construed as a critical, required, or essential feature of any or all the claims.

What is claimed is:

1. A gypsum-based construction material comprising a gypsum core, wherein the gypsum core comprises:
a gypsum component, and
a polymer reinforced foam component comprising a partially hydrolyzed polyvinyl alcohol (PVOH),
wherein the gypsum-based construction material comprises a nail pull resistance of at least about 60 lbf.

2. The gypsum-based construction material of claim 1, wherein the partially hydrolyzed PVOH comprises a degree of hydrolysis of at least about 85% and not greater than about 95%.

3. The gypsum-based construction material of claim 1, wherein the partially hydrolyzed PVOH comprises a pH of at least about 5.5 and not greater than about 7.5.

4. The gypsum-based construction material of claim 1, wherein the gypsum-based construction material comprises a core hardness of at least about 60 N.

5. The gypsum-based construction material of claim 1, wherein the gypsum core comprises a core bubble median size (D50) of at least about 80 microns, and not greater than about 800 microns.

6. The gypsum-based construction material of claim 1, wherein the construction material has a density of at least 1150 lbs/msf and not greater than about 2550 lbs/msf.

7. The gypsum-based construction material of claim 1, wherein the gypsum-based construction material forming composition comprises a pH of at least about 7.6 and not greater than about 9.9.

8. A gypsum-based construction material formed from a stucco-based slurry composition, and a polymer reinforced foam component,
wherein the polymer reinforced foam component comprises a partially hydrolyzed polyvinyl alcohol (PVOH) at a content of not greater than about 10 wt. % for a total weight of the stucco-based slurry composition, and
wherein the gypsum-based construction material comprises a gypsum core having a nail pull resistance of at least about 60 lbf.

9. The gypsum-based construction material of claim 8, wherein the stucco-based slurry composition comprises a stucco component.

10. The gypsum-based construction material of claim 9, wherein the stucco-based slurry composition comprises the stucco component at a content of at least about 10 wt. % and not greater than about 95 wt. % for a total weight of the stucco-based slurry composition.

11. The gypsum-based construction material of claim 9, wherein the stucco-based slurry composition comprises an accelerator component.

12. The gypsum-based construction material of claim 11, wherein the stucco-based slurry composition comprises the accelerator component at a content of at least about 0.1 wt. % and not greater than about 5.0 wt. % relative to the content of the stucco component.

13. The gypsum-based construction material of claim 9, wherein the stucco-based slurry composition comprises a siloxane.

14. The gypsum-based construction material of claim 13, wherein the siloxane comprises PMHS, PDMS, a silanol containing siloxane, or any combination thereof.

15. The gypsum-based construction material of claim 13, wherein the stucco-based slurry composition comprises a siloxane content of at least about 0.01 wt. % and not greater than about 2.0 wt. % relative to the content of the stucco component.

16. The gypsum-based construction material of claim 9, wherein the stucco-based slurry composition comprises a dispersant.

17. The gypsum-based construction material of claim 16, wherein the stucco-based slurry composition comprises the dispersant component at a content of at least about 0.1 wt. % and not greater than about 1 wt. % relative to the content of the stucco component.

18. A method of forming a gypsum-based construction material, wherein the method comprises:
providing a stucco-based slurry composition, a pre-formed polymer reinforced component, and a surfactant, wherein the pre-formed polymer reinforced polymer component comprises a partially hydrolyzed polyvinyl alcohol (PVOH) at a content of not greater than about 10 wt. % for a total weight of the stucco-based slurry composition,
forming a pre-foam mixture by combining the pre-formed polymer reinforced component with the surfactant,
injecting air into the pre-foam mixture to form a polymer reinforced foam component,
mixing the polymer reinforced foam component into the stucco-based slurry composition to form a gypsum-based construction material forming composition, and
forming the gypsum-based construction material forming composition into a gypsum-based construction material.

19. The method of claim 18, wherein the pre-foam mixture further comprises a crosslinker component.

20. The method of claim 19, wherein the crosslinker component comprises sodium trimetaphosphate (STMP).
